(19) United States
(12) Patent Application Publication
(10) Pub. No.: US 2003/0057345 A1
(43) Pub. Date: Mar. 27, 2003

(54) Low friction rocking support apparatus, and fishing pole holding device including same

(76) Inventor: Christopher A. Smith, Wyandotte, MI (US)

Correspondence Address: CARRIER BLACKMAN AND ASSOCIATES, 24101 NOVI ROAD, SUITE 100, NOVI, MI, 48375

(21) Appl. No.: 10/047,748

(22) Filed: Jan. 16, 2002

Related U.S. Application Data
(60) Provisional application No. 60/262,810, filed on Jan. 22, 2001.

(51) Int. Cl. H01Q 1/12

(52) U.S. Cl. 248/538

(57) ABSTRACT

A fishing pole holding device in accordance with the present invention, generally, includes a base member and a cradle for movably resting on the base member. The cradle is constructed and arranged to support a fishing pole thereon, and rockably balances on the base with the fishing pole attached thereto. Since the areas of contact between the base member and cradle are small, a rocking motion imparted to a fishing pole mounted on the cradle will continue for an extended time period.

### BACKGROUND OF THE INVENTION

1. Field of the invention

The present invention relates to a low friction rocking support apparatus, and to a fishing pole holding device including the rocking support apparatus. More particularly, the present invention pertains to a fishing pole holding device in which a fishing pole support cradle, holding a fishing pole thereon, can be movably balanced on a base member.

2. Description of the Background Art

There are many known fishing pole holding devices, which are used throughout the sport of fishing, and which vary greatly in terms of their function and abilities. For example, some of the known devices hold a fishing pole relative to land, some hold a fishing pole relative to a boat, some hold a fishing pole relative to a person's body, etc.

The movement of a fishing pole known as jigging is of particular concern as it relates to the present invention. Jigging involves small, systematic, reciprocal movements of a fishing pole, causing bait on the end of a line, extending from the pole, to move up and down in the water. Jigging is particularly effective when an angler has limited space in which to maneuver the bait. Jigging is commonly used during ice fishing, wherein an angler bores a relatively small hole through ice to access the water below.

There are known fishing pole holding devices that are useful for fishing involving the jigging method. Some of the known fishing pole holding devices automatically create the jigging function through mechanical or electronically powered means, wherein a spring or a battery-powered motor controls jigging movement of the fishing pole.

Despite the availability of powered jigging devices, some anglers also opt for manually operated jigging devices for numerous reasons, including affordability, variable range of the jigging motion, heightened sensitivity of fish activity, etc. Of these, heightened sensitivity of fish is particularly significant.

Some known fishing pole holding devices that permit a jigging function through a non-powered means are illustrated in U.S. Pat. Nos., 5,987,801, 4,033,062, 4,694,603, and 4,161,839, which are discussed further below.

Anderson, U.S. Pat. No. 5,987,801, entitled, “Fishing Rod Holder Tip-Up”, discloses a folding frame apparatus including a fishing rod holder mounted to a clamping harness, pivotally attached to the base portion of the holder, and adapted to normally hold the fishing pole in a “tipup” position. This invention is additionally equipped with a spring-mounted flag, which “tips-up” when the fishing pole is pivoted downward out of the tip-up position, serving as a visual signal to the angler that a fish is on the line.

Denecky, U.S. Pat. No. 4,033,062, entitled, “Fishing Jigs”, discloses a rockable fishing jig that harnesses ambient wind to automatically perform the jigging movement, and which also includes an automatic hook setting mechanism. The rockable fishing jig of Denecky contains a wide piece of ridged material attached to the fishing line, and as the wind moves the material, the material, in turn, moves the fishing line in a jigging motion. The jig integrally includes a portion functioning as a fishing pole, and also includes a spring-loaded, hook setting mechanism which engages when the fishing line is expelled to a predetermined amount. Although this invention performs the jigging function, the jigging function of the device is directly proportional to the force of the wind. As a consequence, should the wind be minimal, so to is the jigging movement. In addition, given the integral nature of the fishing pole portion, the device does not permit the use of conventional fishing poles therewith.

Anderson, U.S. Pat. No. 4,694,603, entitled, “Fishing Device”, discloses a fishing pole holding system adapted for ice fishing. This system contains a tripod-shaped stand and a pivotally attached elevated sleeve for supporting a fishing pole handle in a balanced manner. The fishing pole is balanced such that the pole will tip down when a fish strikes the bait at the end of the fishing line. The fishing pole is attached to the device of Anderson by inserting the fishing pole handle into the elevated sleeve, while balance is achieved by varying the distance between the reel and the pole (such that the reel acts as a counterbalance). Once the pole tips downward, signaling that a fish has contacted the bait, the angler may remove the pole (together with a portion of the support stand) from the tripod base to retrieve the hooked fish. The tripod further contains a guard, which prevents the tip of the pole from lowering beyond a predetermined angle.

Ward, U.S. Pat. No. 4,161,839, entitled, “Swivel Device For Supporting A Balanced Or Semi-Balanced Fishing Rod And Indicating When A Fish Strikes”, discloses an invention for holding a fishing pole while permitting the rod to swivel about a vertical axis and rotate up and down about a horizontal axis. This invention contains a sleeve with a clamping device which is rotatably attached to the sleeve's base portion. When a fish strikes the bait extending from the pole, the pole will pivot down and swivel in whatever direction the fish is moving, and the angler can then remove the pole from the receiving bracket and play the fish.

While each of the aforementioned devices are useful to anglers who desire a manually operated fishing pole holder with a jigging capability and with heightened sensitivity of fish activity, a need still exists in the art for a simple, yet highly versatile fishing pole holder which supports most conventional fishing poles in a balanced, rockable manner. A need also exists for a fishing pole support apparatus which will provide a somewhat automatic jigging movement, without the constant assistance of the angler.

### SUMMARY OF THE INVENTION

A fishing pole holding device in accordance with the present invention, generally, includes a base member and a cradle for use in combination with a fishing pole, and for movably resting on the base member. The cradle is constructed and arranged to support a fishing pole thereon, and rockably balances on the base with the fishing pole attached thereto.

In a preferred embodiment hereof, an apparatus for movably supporting a fishing pole according to the present invention includes a base having two spaced apart support sections for supporting a cradle thereon, with an open space defined between the support sections.

The apparatus also includes a cradle, with a center section having a longitudinal axis, and the cradle also includes a pair of extension arms extending outwardly from opposite sides of the center section. Each of the extension arms is shorter than the cradle center section. The extension arms are attached to an end portion of the cradle center section. Optionally, the extension arms may be pivotally attached to the cradle center section.

Each of the extension arms includes a portion which may be placed so as to substantially define an acute angle with respect to the longitudinal axis of the cradle center section. Preferably, the cradle center section has a central channel formed therein for nestingly receiving a fishing pole handle.

The cradle is constructed and arranged to support a fishing pole thereon, and to rockably balance the fishing pole on the base member when the extension arms are placed on the support sections of the base.

In a first embodiment of the invention, the support sections include wires, and the base includes at least two legs.

In a second embodiment of the invention, an optional mounting bracket is provided for attaching the apparatus to a movable substrate, such as a boat or bucket. In this second embodiment, the mounting bracket includes a backing plate and two hollow, cylindrical sleeves affixed to the backing plate for receiving end portions of the base legs therein.

Correspondingly, it is an object of the present invention to provide a fishing pole holding device that affords a repetitive jigging movement, which, although initiated by the angler, continues for a prolonged period of time, due to good balance and minimal pivot point friction.

It is another object of the invention to provide such a device which provides a highly accurate and extremely sensitive indication of when a fish engages the bait. Essentially, the balanced fishing pole on the holding device functions as an enlarged bobber.

It is yet another object of the invention to provide such a device which can be used in connection with virtually any fishing pole.

It is still another object of the invention to provide such a device which can be used in almost any location where fishing is operable.

It is another object of the invention to provide such a device, which permits a fishing pole to be readily separated from the base by the angler, to allow playing and retrieving a hooked fish.

It is a further object of the invention to provide such a device which affords an angler a broad range of jig movement capability.

Other objects, advantages and salient features of the invention will become apparent from the following detailed description which, when read in conjunction with the annexed drawings, discloses the presently preferred embodiments of the invention.

### BRIEF DESCRIPTION OF THE DRAWINGS

FIG. 1 is an exploded perspective view of a fishing pole holder according to a first embodiment of the present invention, shown with a fishing pole attached thereto;

FIG. 2 is a perspective view of a support base which is a first component of the fishing pole holding device of FIG. 1;

FIG. 2A is an enlarged view of a leg tip portion of the support base of FIG. 2;

FIG. 3 is a top perspective view of a rocking bracket or cradle which is a 2^{nd} component of the device of FIG. 1;

FIG. 3A is a perspective view of an optional fastener usable to connect a fishing pole to the cradle of FIG. 3;

FIG. 4 is a front plan view of an optional support bracket for a fishing pole holding device according to a second embodiment of the invention, which can be mounted to a movable support such as a five-gallon bucket (as shown), a boat, etc; and

FIG. 5 is an exploded perspective view of a bucket and a fishing pole support apparatus in accordance with a third embodiment of the invention.

### DETAILED DESCRIPTION OF THE PREFERRED EMBODIMENTS

The present invention provides a base stand and cradle system for supporting a fishing pole, while allowing the fishing pole to effectively operate in a repetitive jigging motion.

### Overview

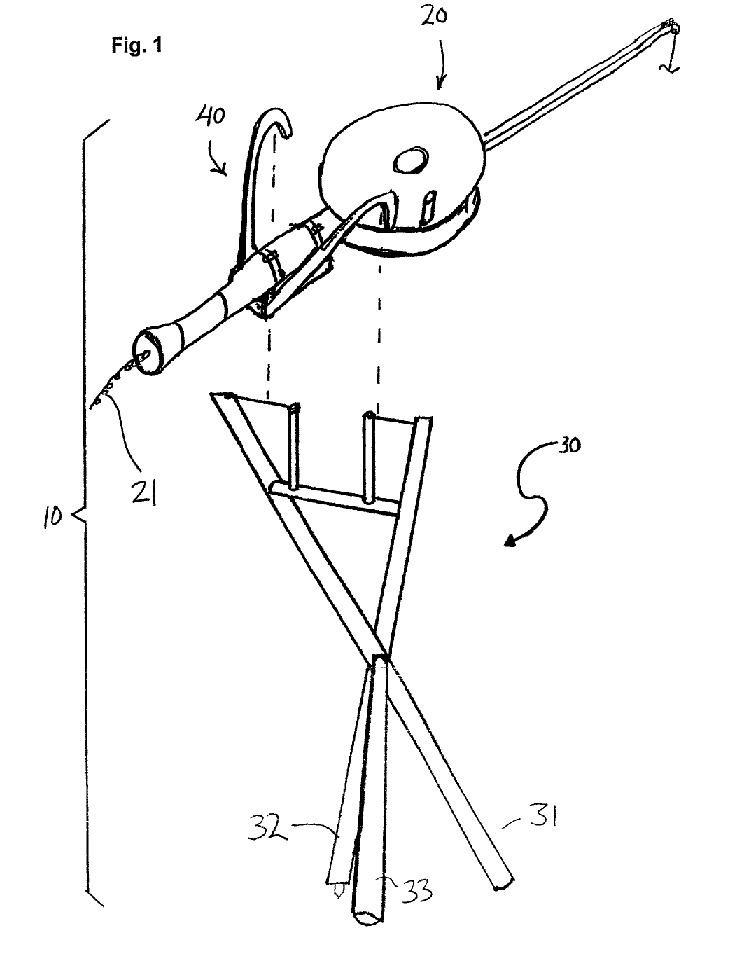

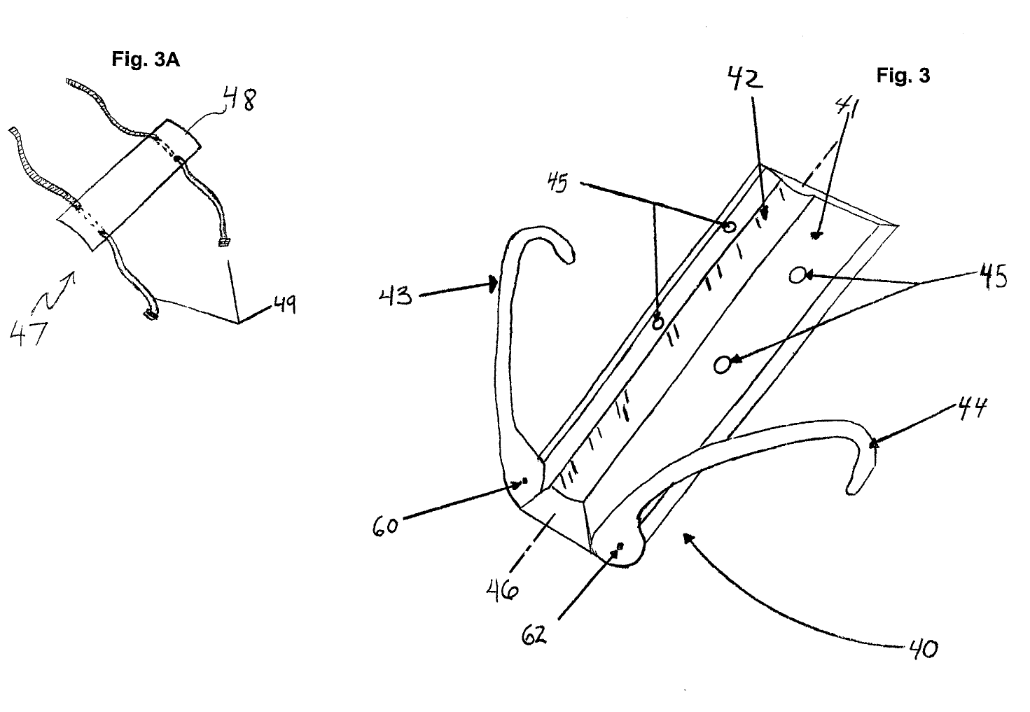

Referring to FIGS. 1-3, a fishing pole holding device according to a first embodiment of the invention is shown generally at 10, in combination with a conventional ice-fishing pole 20. The device 10 in this embodiment generally includes a support base 30, a rockable cradle 40, and a fastening means 47 (FIG. 3A) for securing a fishing pole 20 to the cradle 40.

The apparatus 10 according to the present invention may include a fishing pole 20, or alternatively may be provided without a fishing pole, for use with a conventional fishing pole provided by a user. Accordingly, the fishing pole 20 is an optional, rather than a necessary component of fishing pole support apparatus according to the invention.

### The Support Base

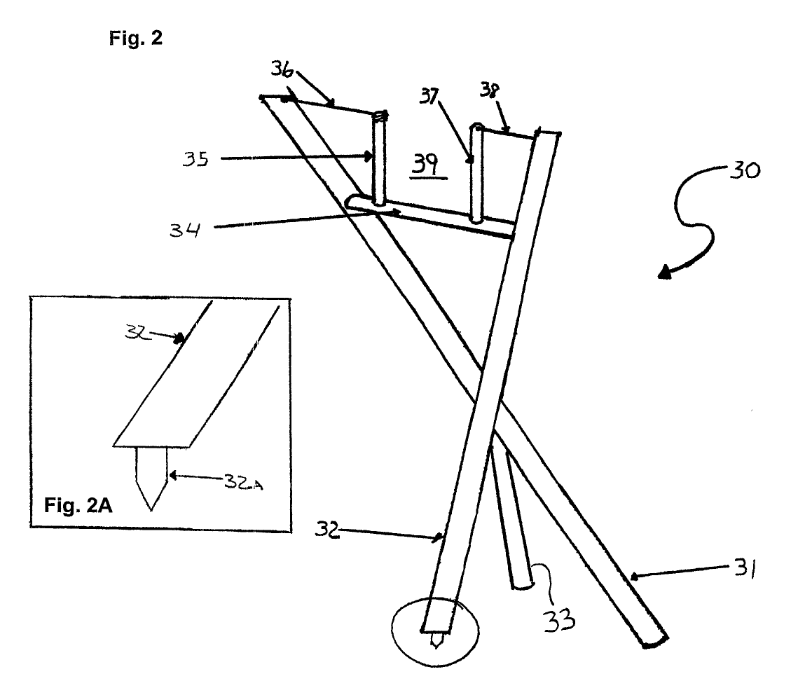

In the embodiment shown in FIGS. 1-2, the support base 30 is generally in the form of a tripod with a substantially v-shaped upper section. The support base 30 of this first embodiment incorporates three stabilizing legs 31, 32 and 33, such that two primary stabilizing legs 31 and 32 intersect creating an “X” shape, while the third stabilizing leg 33 is attached to, and extends outwardly from the intersection point of the primary legs 31 and 32. This third stabilizing leg 33 is preferably pivotally attached to the other two legs 31, 32 and is collapsible to permit ease in transportation and storage of the apparatus 10. It will be noted that the third stabilizing leg 33 is shorter than the primary legs 31 and 32, and does not extend upwardly beyond the intersection point of the primary legs.

The legs 31-33 may be formed of metal tubing such as steel or aluminum. Other usable materials for the support base 30 include wood and non-brittle plastics.

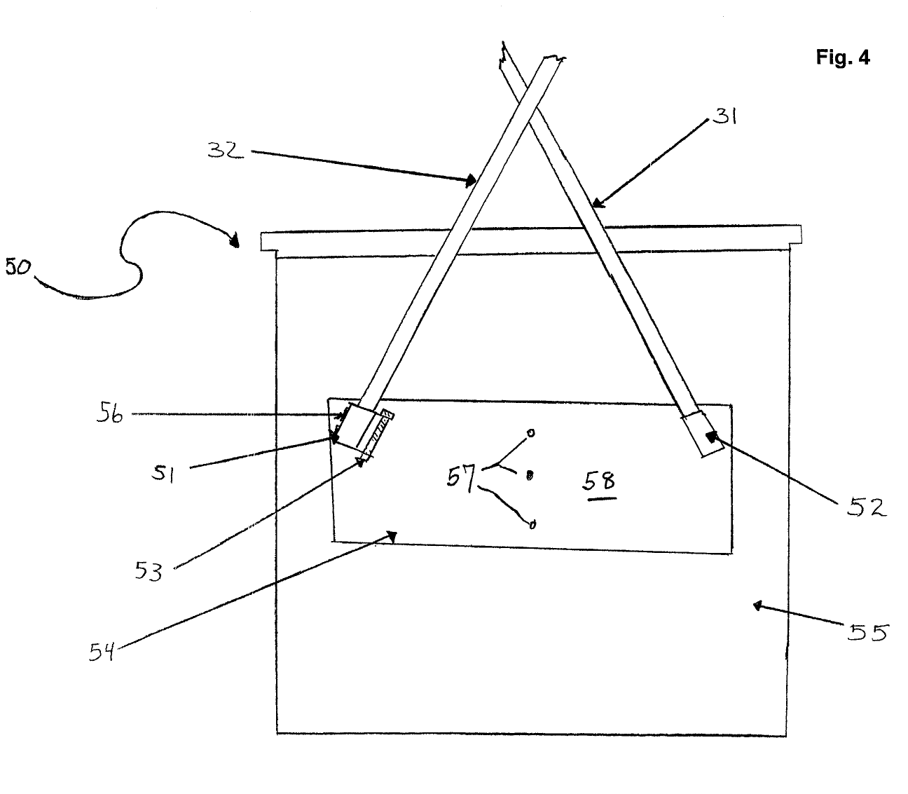

Optionally, the third stabilizing leg 33 may be made removable relative to the primary legs 31 and 32, by any appropriate means, to allow the primary legs 31, 32 to be removably mounted to a movable support, such as a bucket, seat, pole, boat, etc. (as illustrated in connection with a bucket in FIG. 4, and as discussed further below).

As will be understood, in a modified version, the apparatus according to the present invention may incorporate other supporting bases than the tripod-type base 30 as shown. For example, a single support shaft or stabilizing leg, which may be driven in to the ground or otherwise secured to a supporting substance such as a boat, to provide adequate stabilization for the device may be used, instead of the tripod-type base.

The support base 30 may, optionally, include a pointed foot spike 32a attached to the bottom of each leg, as shown in FIG. 2A, for stabilizing the device on land or ice.

Referring again to the embodiment of FIGS. 1-3, at the upper end of the support base 30 a cross member 34 is horizontally attached to the upper portions of the primary stabilizing legs 31 and 32, so as to interconnect the same. The support base 30 also includes two substantially vertical support members 35 and 37, attached to the horizontal cross member 34 and extending upwardly therefrom. The two substantially vertical support members 35 and 37 extend upward to a fixed height, substantially the same as the height of the tops of the two primary stabilizing legs 31 and 32.

The cross member 34 and support members 35 and 37 are preferably formed of materials similar to that used for the legs 31-33.

The support base 30 additionally includes two small wires 36 and 38 tensionally extending from the uppermost part of each of the two respective primary stabilizing legs 31, 32 to the top of the respective adjacent vertical support member 35, 37, as shown. The wires 36 and 38 are preferably formed of a pliable metal such as galvanized steel, and may have a thickness of 8-16 gauge, for example.

A first wire 36 therefore extends between the top of the first leg 31 and the top of the first vertical support member 35, while a second wire 38 extends between the top of the second leg 32 and the top of the second vertical support member 37. This results in the wires extending substantially horizontally in line with one another across the top outside portions of the base 30, as shown. As a result of the described position of the attached wires 36, 38, a spatial void or opening 39 is provided between the two vertical support members 35 and 37. This opening 39 is provided to accommodate the cradle 40 with the pole 20 thereon, and to allow the cradle to move freely between the vertical support members 35 and 37.

The wires 36 and 38 function to pivotally support the rockable cradle 40 in a very low friction manner due to a minimal area of contact therebetween, according to an important aspect of the invention as discussed further below.

While components of the preferred embodiment of the invention are constructed from metal, the support base 30 may optionally be formed from molded plastic tubing such as PVC or other strong plastic. Furthermore, while the wires 36 and 38 of the support base preferably consist of pliable metal, other appropriate materials capable of forming a narrow, rounded, rigid low friction support surface between primary legs 32 and 31 and vertical support members 35 and 37 may be used. Examples of other suitable materials include nylon string of 8-16 gauge, braided nylon cord of similar thickness, thin metal rods, thin sheets or bars of solid plastic, etc.

### The Cradle

Referring to FIG. 3, the cradle 40 of the apparatus includes an elongate, substantially flat center section 41, with a concave top central channel 42 formed therein. The center section 41 has a longitudinal axis 46, and is generally symmetrical on each side of the longitudinal axis, as shown.

The cradle 40 also includes two extension arms 43 and 44, connected to one end of the center section 41, and extending upwardly and outwardly, from respective opposite sides thereof. Each of the extension arms 43, 44 includes a portion which substantially defines an acute angle with respect to the longitudinal axis 46 of the center section 41.

The free ends of the extension arms 43 and 44 are preferably curved downwardly in a hook shape as shown, and are provided for respective placement over the wires 36 and 38 of the base, for rockably securing the cradle 40 to the support base 30.

As shown, the elongate center section 41 is substantially longer than the extension arms 43 and 44. The extension arms 43 and 44 extend outwardly at the sides of the center section 41, such that the upper ends of the extension arms can be engaged over the wires 36 and 38, while the center section 41 extends beyond the extension arm ends and through the space 39, and can be freely rocked back and forth through the space 39. The extension arms 43 and 44 also extend upwardly relative to the center section 41, for example at an angle of 30°-60°, which promotes extended rocking motion of the cradle 40 when the fishing pole 20 is attached thereto in a balanced manner.

Optionally, the extension arms 43 and 44 may be made pivotable about pivot pins 60 and 62 relative to the center section 41between operative positions (as shown) and collapsed positions adjacent to the center section 41, for storage and transportation of the apparatus 10.

The cradle 40 is also provided with a securing means 47 (see FIG. 3A) for attaching a fishing pole 20 to the center section 41. The securing means 47 may, optionally, include a cross-sectionally U-shaped channel member 48, which conforms to the curved nature of most fishing pole handles. The securing means 47 is also equipped with tightening mechanisms, such as conventional adjustable tie-down straps 49. The tightening mechanisms are extended through openings formed in the channel member 48, and through corresponding openings 45 formed through the cradle 40, to accommodate fishing poles of varying diameters.

As an alternative securing means, and as shown in FIG. 7, the channel member 48 may be omitted, and the fishing pole 20 may be secured to the cradle 40 using conventional tie straps 49 exclusively.

### Method of Operation

To assemble the fishing pole holding device 10, first, a fishing pole 20 is loosely attached to the cradle 40 using the attachment means 47. Then, the cradle 40 is placed on the support base 30 by placing the hooked outer ends of the extension arms 43 and 44 over the base wires 36 and 38, such that the cradle is suspended within the spatial void 39 between the two vertical support members 35 and 37 of the support base 30. The fishing pole 20 and cradle 40 are then balanced, with the pole handle adjustably supported in the central channel 42 of the cradle's base member 41, in a manner such that the fishing pole freely rests on a plane approximately parallel with the ground. Once the pole 20 is positioned on such a plane, the pole is then tightly secured in the cradle's central channel 42 using the fasteners 49. Due to the proper balancing of the fishing pole, and the miniscule contact points on which the cradle 40 pivots relative to the base 30 (the engaged areas of the extension arms 43 and 44 and wires 36 and 38), the rocking or jigging motion of the pole and cradle is easily facilitated through a slight touch by the angler to either end of the fishing pole, either directly or, alternatively, through the optional use of a remote activation means such as a string 21 (FIG. 1) attached to an end of the fishing pole handle 22.

This motion will continue for an extended period of time, given numerous variables (weight of the bait, height and frequency of waves, degree of water current, etc.). It is the present invention's incorporation of proper pole balancing and minimal engaging surfaces at the pivot points which provide an angler with “hands free” jigging for a longer time period relative to other jigging devices, allowing the angler to perform other tasks while the jigging motion continues. Should the jigging movement slow to undesired frequency, the angler need only touch one end of the fishing pole or tug on the remote activation means 21 to restore the motion to the desired rate.

While the designed minimal friction pivot points and proper pole balancing afford the angler with substantially “hands free” jigging operation, these features also offer the angler other benefits which overcome other deficiencies of the prior art. Due to the positioning of the cradle to the base stand, the jigging motion may span as small or as great a range as the angler desires, free of any encumbrances. The low friction and proper balance features also transfer a greater degree of sensitivity from the fishing line to the fishing pole, affording the angler with more opportunity to notice and respond to the slightest fish activity.

Additionally, since the cradle is removably attached to the fishing pole and only minimally resting on the base stand, the angler is afforded a quicker response time to fish activity since the angler need only pick up his/her fishing pole with the attached cradle 40, since there is no direct attachment between the cradle 40 and the base 30.

### Modified Embodiment-Mounting the Apparatus to a Movable Support

Referring now to FIG. 4, a fishing pole support apparatus according to a second embodiment of the invention is shown mounted to a conventional five-gallon bucket 55. This alternative mounting system, shown generally at 50, illustrates use of the support base 30 as previously discussed, modified by having the third leg 33 removed. The primary legs 31, 32 are removably attached to the five-gallon bucket 55, for example, by the use of a mounting bracket 54.

The mounting bracket 54 includes a backing plate 58 having two hollow, cylindrical receiving sleeves 51 and 52 fixed thereon, which respectively receive the ends of legs 31 and 32 of the support base 30, in a secure manner. Conventional fastening means such as bolts (not shown) extend through openings 57 formed through the backing plate 58, and through corresponding openings provided in the bucket 55. Those in the art will understand that a differently-shaped backing plate would be used for a boat than for a cylindrical bucket, and that a suitable bracket could be fabricated to fit any substrate of choice.

One of the receiving sleeves, shown in FIG. 4 as sleeve 52, is constructed from a unitary piece of tubing with an inner diameter slightly larger than the outer diameter of the end of leg 31, while the other sleeve 51 is constructed from split of a piece of tubing joined together by a hinge 56. The split sleeve 51 locks and releases the leg 32 to the mounting bracket through a locking fastener 53, which includes, for example, a circular washer fixed to opposite ends of the split sleeve halves and a bolt extended between the washers. The use of the mounting bracket 54 permits the base 30 to be secured to a movable object of the angler's choice such as a five-gallon bucket 55 (as shown in FIG. 4), a boat, a pole, etc.

The cradle 40, as previously shown and described, is used with a conventional fishing pole 20, and is rockably balanced on the upper part of the base 30 as discussed above.

### Third Embodiment

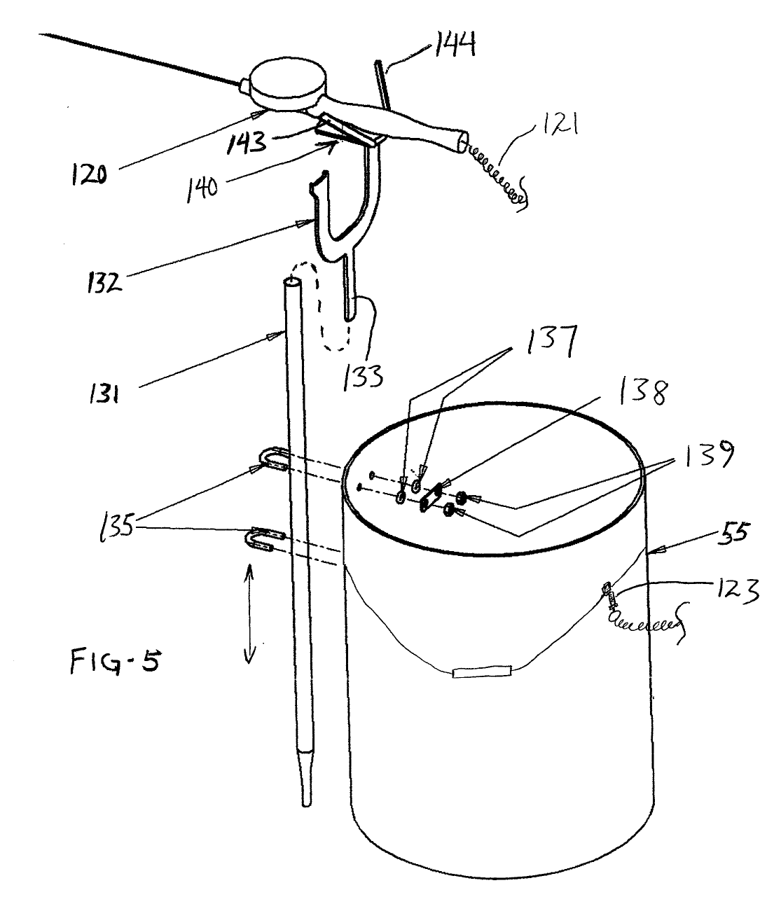

Referring now to FIG. 5, a third embodiment of a fishing pole support apparatus according to the invention is shown generally at 110, along with a conventional bucket 55 as a substrate for supporting the apparatus. The apparatus 110 includes a support base 130 and a cradle 140 which, when used together with a fishing pole 120, balances on the support base 130.

In this embodiment, the cradle 140 is substantially similar to the cradle 40 as previously described. Optionally, the hooked ends of the extension arms may be replaced by notches formed in substantially straight extension arms 143, 144.

However, in this third embodiment 110, the support base 130 includes a hollow tube 131 and a Y-shaped bracket 132.

The Y-shaped bracket 132 has a center stem 133 that fits within the top of the hollow tube 131, and also includes a pair of upstanding posts 134, 136 extending upwardly in opposite directions from the center stem. An open space is defined between the posts 134, 136.

The hollow tube 131 may be attached to the bucket 55, or to a boat or other substrate using conventional fasteners such as, e.g., U-Bolts 135, washers 137, a backing plate 138 and nuts 139. Alternatively, it will be understood that the hollow tube 131 may be made with a downwardly extending clip (not shown) attached medially thereto, and the clip may be slid or clipped on to an upper rim of the bucket 55.

In this embodiment, instead of the wires that were previously used in the support member, the extension arms 143, 144 of the cradle 140 rest and balance on top of the upper edges of the posts 134, 136 on the Y-shaped bracket 132. Once again, this provides minimal contact between the moving parts, and also provides an open space between the balance surfaces to accommodate the cradle 140 and fishing pole 120, and to allow the cradle to rock freely on the support base 130.

Once again, a string 121 may be attached to the handle of the pole 120, to provide a remote activation means. Where the string 121 is used, a spring-loaded connector 123 may be provided at the end of the string opposite the fishing pole, to allow for attachment to part of the bucket 55 or other convenient point on the substrate being used. The clip 123 provides for recovery of the pole 120, in the event that a fish takes the bait and pulls the pole and cradle off of the support.

Although the present invention is described with specificity, the foregoing description is intended to be an illustration, and not a restriction in the scope of the invention. Those skilled in the art will realize that many modifications of the embodiment could be made which would be operable. All such modifications which are within the scope of this description are intended to be within the scope and spirit of the present invention.

I claim:

1. An apparatus for movably supporting a fishing pole, comprising:
a base having two spaced apart support sections for supporting a cradle thereon, with an open space defined between the support sections;
a cradle, comprising:
a center section having a longitudinal axis, and
a pair of extension arms extending outwardly from opposite sides of the center section, each of said extension arms comprising a portion which may be placed so as to substantially define an acute angle with respect to the longitudinal axis of the cradle center section;
wherein the cradle is constructed and arranged to support a fishing pole thereon and to rockably balance said fishing pole on the base member when the extension arms are placed on the support sections of the base.

2. The apparatus of claim 1, wherein the support sections comprise wires.

3. The apparatus of claim 1, wherein the base comprises at least two legs.

4. The apparatus of claim 3, further comprising a mounting bracket which comprises:
a backing plate; and
two hollow, cylindrical sleeves affixed to the backing plate for receiving end portions of the base legs therein.

5. The apparatus of claim 1, further comprising a fishing pole.

6. The apparatus of claim 1, wherein the cradle center section has a central channel formed therein for nestingly receiving a fishing pole handle.

7. The apparatus of claim 1, wherein the extension arms are pivotally attached to the cradle center section.

8. The apparatus of claim 1, wherein each of the extension arms is shorter than the cradle center section.

9. The apparatus of claim 8, wherein the extension arms are attached to an end portion of the cradle center section

10. The apparatus of claim 1, wherein the angle between the extension arms and the cradle longitudinal axis is between 30-60 degrees.

11. An apparatus for movably supporting a fishing pole, comprising:
a base comprising two posts which are connected to one another at the bottom ends thereof, and with an open space defined between the upper ends of said posts, said posts defining two spaced apart support sections for supporting a cradle thereon; and
a cradle for rocking placement on the base, said cradle comprising:
a center section having a longitudinal axis, and
a pair of extension arms extending outwardly from opposite sides of the center section, each of said extension arms comprising a portion which is placeable so as to substantially define an acute angle with respect to the longitudinal axis of the cradle center section;
wherein the cradle is constructed and arranged to support a fishing pole thereon, and to rockably balance said fishing pole on the base member when the extension arms are placed on the support sections of the base.

12. The apparatus of claim 11, wherein the support sections comprise wires.

13. The apparatus of claim 11, wherein the base comprises at least two legs.

14. The apparatus of claim 13, further comprising a mounting bracket which comprises:
a backing plate; and
two hollow, cylindrical sleeves affixed to the backing plate for receiving end portions of the base legs therein.

15. The apparatus of claim 11, further comprising a fishing pole.

16. The apparatus of claim 11, wherein the cradle center section has a central channel formed therein for nestingly receiving a fishing pole handle.

17. The apparatus of claim 11, wherein the extension arms are pivotally attached to the cradle center section.

18. The apparatus of claim 11, wherein each of the extension arms is shorter than the cradle center section.

19. The apparatus of claim 18, wherein the extension arms are attached to an end portion of the cradle center section.
